(19) United States
(12) Patent Application Publication
(10) Pub. No.: US 2006/0214462 A1
(43) Pub. Date: Sep. 28, 2006

(54) AUTOMOTIVE INTERIOR TRIM

(76) Inventors: Glen A. Cowelchuk, Chesterfield Township, MI (US); Todd L. DePue, Brighton, MI (US); Robert J. Adams, Ypsilanti, MI (US)

Correspondence Address: WOOD, HERRON & EVANS, LLP, 2700 CAREW TOWER, 441 VINE STREET, CINCINNATI, OH, 45202, US

(21) Appl. No.: 11/423,981

(22) Filed: Jun. 14, 2006

Related U.S. Application Data
(63) Continuation-in-part of application No. 10/708,528, filed on Mar. 10, 2004, now Pat. No. 7,063,369.

(51) Int. Cl. B62D 25/14

(52) U.S. Cl. 296/70

(57) ABSTRACT

Interior trim assemblies for automobiles that eliminate gaps between the trim assemblies and adjacent components in the interior of the automobile. The trim assemblies comprise rigid substrate members with pliable cover layers disposed on the rigid substrate members. In one embodiment, the substrates include central and lateral sections connected by the pliable cover layers. The lateral substrate sections may be deformed toward the central substrate section to accommodate variations in spacing between components, and to eliminate gaps therebetween. In another embodiment, the cover layers include resilient, non-corrugate free ends that extend outwardly from edge portions of the rigid substrates to define flexible flanges that contact adjacent automotive components to eliminate gaps between the trim assemblies and the adjacent components.

This application is a continuation-in-part of U.S. patent application Ser. No. 10/708,528 (pending) filed Mar. 10, 2004.

### FIELD OF THE INVENTION

The present invention pertains generally to automotive interior trim components, and more particularly to automotive interior trim components that provide improved aesthetic appearance by eliminating visible gaps between adjacent interior components.

### BACKGROUND OF THE INVENTION

It is known to outfit automotive interiors with various trim components to enhance the aesthetic appearance of the automotive interior and to provide comfort and convenience to vehicle occupants. For example, automotive interiors are typically provided with door trim panels, instrument panels and console cover panels. The instrument panel is provided in a portion of the passenger compartment, at a position forward of the vehicle occupants and disposed laterally between the door panels. Typically, automotive manufacturers strive to provide a clearance between the ends of the instrument panel and the adjacent door panels to avoid interference between these components and thereby facilitate easy closing of the automobile doors. In typical constructions, the smallest gap between the instrument panel and an adjacent door panel may be about 5 mm. Similarly, gaps occur between various other adjacent components in the interior of a vehicle, as a result of the integration of the many individual components used to manufacture the vehicle interior. While these gaps avoid interference due to the cumulative effects of tolerance variations in the assembled components in the automobile, they also detract from the aesthetic appearance of the trim components. A need therefore exists for automotive interior trim components that eliminate the gaps between adjacent components to further improve the aesthetic appearance of the interior trim.

### SUMMARY OF THE INVENTION

The present invention provides an automotive trim assembly that eliminates gaps between adjacent components in the interior of a vehicle. In accordance with one aspect of the invention, a trim assembly cooperates with a movable component of the vehicle to eliminate gaps between the trim assembly and the movable component. In another aspect, a trim assembly in accordance with the principles of the invention eliminates gaps between the trim assembly and a stationary component of the vehicle.

In one embodiment, an instrument panel in accordance with the principles of the invention eliminates the gaps between lateral ends of the instrument panel and adjacent door panels of an automobile in which the instrument panel is installed, when the doors are in their closed positions. The instrument panel includes a substrate member that defines the general shape of the instrument panel, and a pliable cover layer disposed over the substrate member. The substrate has lateral end portions configured to confront respective portions of the door panels located adjacent lateral ends of the instrument panel. The substrate member and cover layer together define resilient engagement areas at the lateral ends of the instrument panel which contact the adjacent door panels and which deform when the doors are moved to their closed positions such that proper closing of the doors is not inhibited by the contact.

In another embodiment, the pliable cover layer extends beyond the lateral end portions of the substrate member to define flexible flanges for engaging the door panels. When the doors of the automobile are moved to their respective closed positions, the flanges deform to accommodate the respective door panels.

In another embodiment, the substrate member includes a central substrate section and lateral substrate sections disposed on respective lateral ends of the central substrate section. The lateral substrate sections are spaced from the central substrate section and are flexibly connected to the central substrate section by the pliable cover layer. When the doors of the automobile are moved to their closed positions, the lateral substrate sections contact the respective door panels and deform toward the central substrate section to accommodate the door panels.

In another embodiment, a method of finishing an interior of an automobile includes installing an instrument panel having lateral ends that define resilient engagement areas, contacting a door panel of the automobile with the instrument panel, proximate the resilient engagement areas when the door panel is moved to a closed position, and deforming the instrument panel to accommodate the door panel.

In another embodiment, an automotive interior trim assembly includes rigid substrate member with an edge portion that defines a boundary proximate an adjacent automotive component. A pliable cover layer on the substrate member includes a resilient, non-corrugate free end that extends outwardly from the edge portion to define a flexible flange cantilevered from the substrate member and contacting the adjacent automotive component such that no gap is visible between the trim assembly and the adjacent component. A trim assembly in accordance with the principles of the present invention may be a cover for one of the pillars of the automobile, a cover for a center console, a cover for a shifter assembly, trim for the center console, a door to a glove box, or various other trim components provided in the interior of an automobile.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention.

FIG. 1 is a perspective view of a typical automotive installation including an exemplary instrument panel in accordance with the principles of the present invention;

FIG. 2A is a partial cross-sectional view taken along line 2-2 of FIG. 1 and depicting one embodiment of an instrument panel in accordance with the principles of the present invention;

FIG. 2B is a partial cross-sectional view, similar to FIG. 2A, depicting another embodiment of an instrument panel in accordance with the principles of the present;

FIG. 2C is a partial cross-sectional view, similar to FIG. 2A, depicting yet another embodiment of an instrument panel in accordance with the principles of the present invention;

FIG. 2D is a partial cross-sectional view, similar to FIG. 2A, depicting yet another embodiment of an instrument panel in accordance with the principles of the present invention;

FIG. 3 is a perspective view of the interior of an automobile, including various trim components in accordance with the principles of the present invention;

FIG. 4 is a cross-sectional view of the automobile interior of FIG. 3, taken along line 4-4, illustrating a glove box door in accordance with the principles of the present invention;

FIG. 5 is a cross-sectional view of the automobile interior of FIG. 3, taken along line 5-5, illustrating a center console trim in accordance with the principles of the present invention;

FIG. 6 is a cross-sectional view of the automobile interior of FIG. 3, taken along line 6-6, illustrating a shifter assembly in accordance with the principles of the present invention;

FIG. 7A is a cross-sectional view of the automobile interior of FIG. 3, taken along line 7-7, illustrating a B-pillar trim assembly in accordance with the principles of the present invention;

FIG. 7B is a cross-sectional view of the automobile interior of FIG. 3, similar to FIG. 7A, but illustrating another B-pillar trim assembly in accordance with the principles of the present invention;

FIG. 8 is a cross-sectional view of the automobile interior of FIG. 3, taken along line 8-8, illustrating an A-pillar trim assembly in accordance with the principles of the present invention; and

FIG. 9 is a cross-sectional view of the automobile interior of FIG. 3, taken along line 9-9, illustrating a cover for a storage compartment of a center console in accordance with the principles of the present invention.

### DETAILED DESCRIPTION

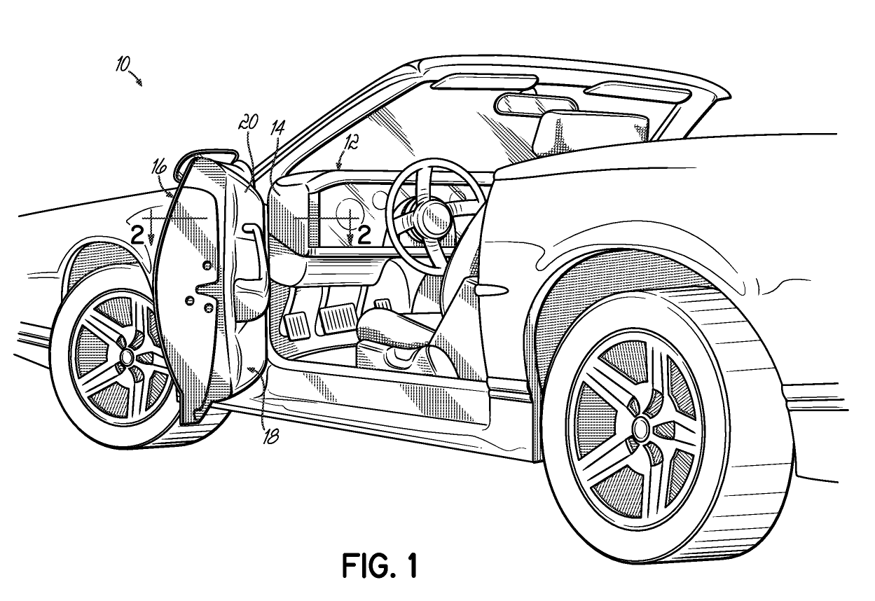

Referring to FIG. 1, an automobile 10 includes an exemplary instrument panel 12 according to an embodiment of the present invention. The instrument panel 12 is installed in a forward portion of the passenger compartment of the automobile 10, and has opposed lateral ends 14 (one of which is shown in FIG. 1). The automobile 10 further includes a door 16 hingedly secured to the automobile 10 for movement between open and closed positions. The door 16 includes an interior door panel 18, a portion of which (designated at 20) confronts the lateral end 14 of the instrument panel when the door 16 is in the closed position. While only one door 16 and lateral end 14 of instrument panel 12 is shown in FIG. 1, it will be understood that another door 16 and another lateral end 14 are provided on the opposite side of the automobile 10.

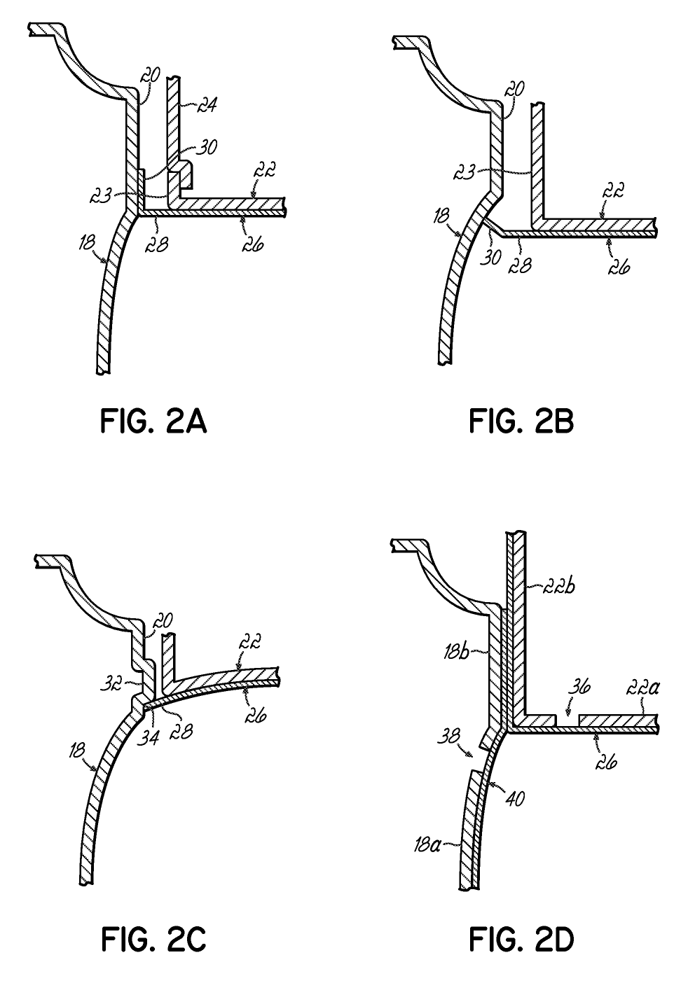

Referring now to FIG. 2A, there is shown a partial cross-sectional view of the lateral end 14 of the instrument panel 12 and the door panel 18 when the door 16 is in the closed position. As shown in FIG. 2A, instrument panel 12 includes a substrate member 22 which defines the general shape of the instrument panel 12 and which may be secured within the interior of the automobile 10, for example, to a bracket or mounting member 24. The instrument panel 12 further includes a pliable cover layer 26 disposed over the substrate member 22 to provide an aesthetically pleasing appearance to the instrument panel 12. In the embodiment shown in FIG. 2A, the cover layer 26 extends beyond the lateral end portion 23 of the substrate 22 to define a flexible flange 28 that contacts the door panel 18 adjacent the confronting area 20 when the door panel 18 is in the closed position. A distal end 30 of the flange 28 is formed at an angle so that door panel 18 contacts a side surface of the flange 28 in the closed position. Advantageously, the flange 28 may be displaced toward the substrate member 22 when the door panel 18 is moved to the closed position to accommodate variation in the spacing between the door panel 18 and the substrate member 22, which may be due to the accumulation of tolerance variations of the assembled automotive components, or to variation in the relative position of the components which may occur over the life of the automobile.

FIG. 2B illustrates another embodiment of an instrument panel in accordance with the principles of the present invention. In this embodiment, the flange 28 includes a distal end 30 which is angled toward substrate member 22 such that door panel 18 contacts an edge of the flange 28 in the closed position. Accordingly, the angled distal end 30 facilitates flexing of the flange 28 when door panel 18 is moved to the closed position to thereby provide contact with the door panel 18 without inhibiting closing of the door 16.

FIG. 2C, illustrates yet another embodiment of an instrument panel wherein a flange 28 defined by outwardly extending cover layer 26 does not have an angled distal end. In this embodiment, door panel 18 is configured to include a laterally extending boss 32 which faces the lateral end 14 of the instrument panel, and a groove 34 adjacent the boss 32 and positioned to received the flange 28 of the instrument panel when the door panel 18 is in the closed position.

In FIG. 2D, there is shown yet another embodiment of an instrument panel and a door panel 18 according to the present invention. In this embodiment, the instrument panel includes a central substrate section 22a and first and second lateral substrate sections 22b separated by a space 36. Only one lateral substrate section 22a is shown in FIG. 2D, it being understood that another similar substrate section 22a is provided at the opposite lateral end 14 of the instrument panel.

The central substrate section 22a and first and second lateral substrate sections 22b are flexibly connected by the cover layer 26 which extends over the space 36. When door panel 18 is moved to the closed position, the instrument panel 12 contacts the confronting area 20 of door panel 18 and the lateral substrate section 22b is displaced in a direction toward the central substrate section 22a to facilitate closing of the door 16. In this embodiment, door panel 18 may also comprise first and second door substrate members 18a, 18b having a space 38 therebetween and connected by a second, pliable cover layer 40 disposed over the first and second door substrate members 18a, 18b and across the space 38. Advantageously, the second door substrate section 18b may also be displaced, generally in a direction opposite the lateral substrate section 22b, when door panel 18 is moved to a closed position. While this embodiment depicts both an instrument panel and a door panel configured to accommodate contact between the instrument panel and door panel, it will be recognized that the instrument panel may alternatively be a conventional instrument panel, without lateral substrate sections 22b or flexible flanges 28, whereby contact between the instrument panel and door panel 18 is accommodated solely by the second door substrate section 18b and second cover layer 40.

In another embodiment, the substrate member 22 of the instrument panel 12, the first and second door substrate sections 18a, 18b, and the first and second cover layers 26, 40 may be formed from injection moldable polymers. For example, substrate members 22, 18 may be formed from thermoplastic olefin, acrylonitrile butadiene styrene, styrene maleic anhydride, polycarbonate/acrylonitrile butadiene styrene alloy, or other materials suitable for molding a rigid substrate member. The flexible cover layers 26, 40 may be formed from vinyl, thermoplastic elastomer, PVC, or other suitable materials for molding the flexible cover layers 26, 40. Alternatively, the cover layers 26 may be formed from fabric or leather and fitted over the molded substrate member 22, 18a, 18b, as known in the art. Advantageously, the instrument panel 12 and door panel 18 of the present invention may be formed in a two-shot molding operation wherein the substrate members 22, 22a, 22b, 18a, 18b are formed during a first shot of the molding process, and the cover layers 26, 40 are molded over the substrate members 22, 22a, 22b, 18a, 18b during a second shot of the molding operation.

In another embodiment of the invention, a method of finishing an interior of an automobile 10 includes installing an instrument panel 12, as described above, within the interior of the automobile 10 and between laterally opposed door panels 18, contacting the door panels 18 with the instrument panel 12, adjacent the lateral ends 14 of the instrument panel 12 when the doors 16 are in their closed positions, and displacing at least a part of the instrument panel 18 to accommodate the door panels 18 in their closed positions.

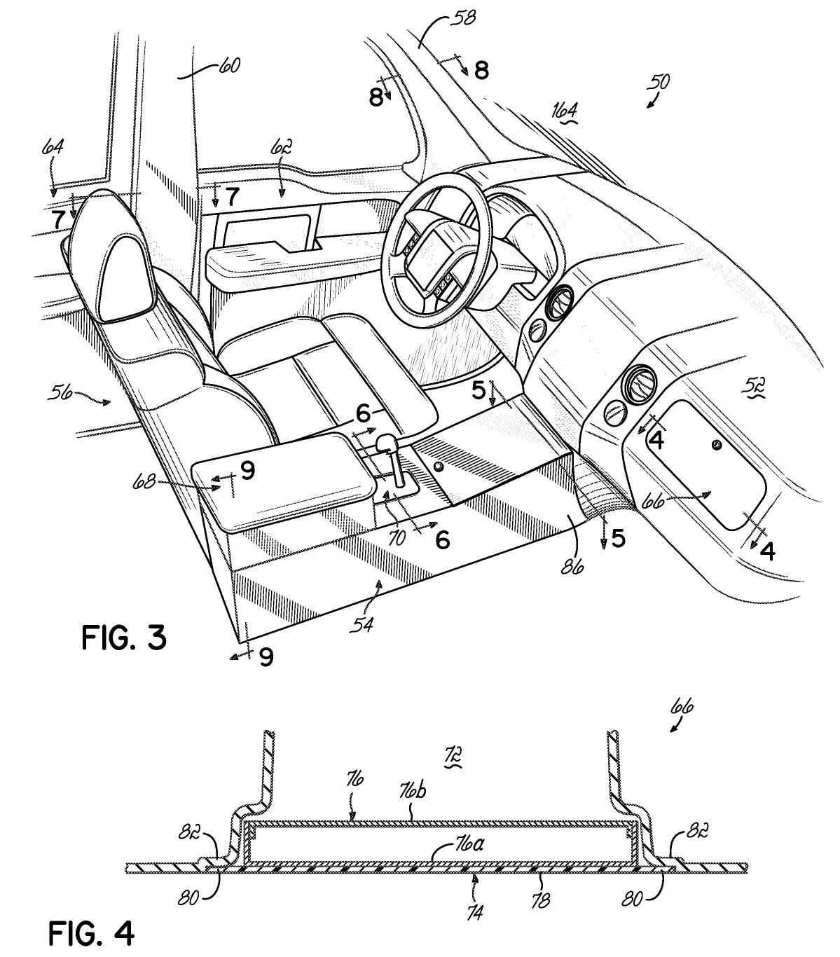

FIG. 3 depicts another exemplary automobile interior 50 depicting various other trim assemblies installed within the interior 50 of the automobile, in accordance with the principles of the present invention. The automobile interior 50 generally includes an instrument panel 52, a center console 54 disposed between the driver and passenger seats (only the driver seat 56 is shown), A-pillar assemblies 58 extending generally between the front doors 62 and the windshield 164, and B-pillar assemblies 60 extending generally between the front and rear doors 62, 64 (only the driver's-side pillars 58, 60 and doors 62, 64 are illustrated). The instrument panel 52 is provided with a storage compartment, or glove box 66, on the passenger side of the vehicle, and the center console 54 includes a separate storage area/armrest 68 disposed between the driver's seat 56 and the passenger's seat (not shown). The center console 54 may also support a shifter assembly 70.

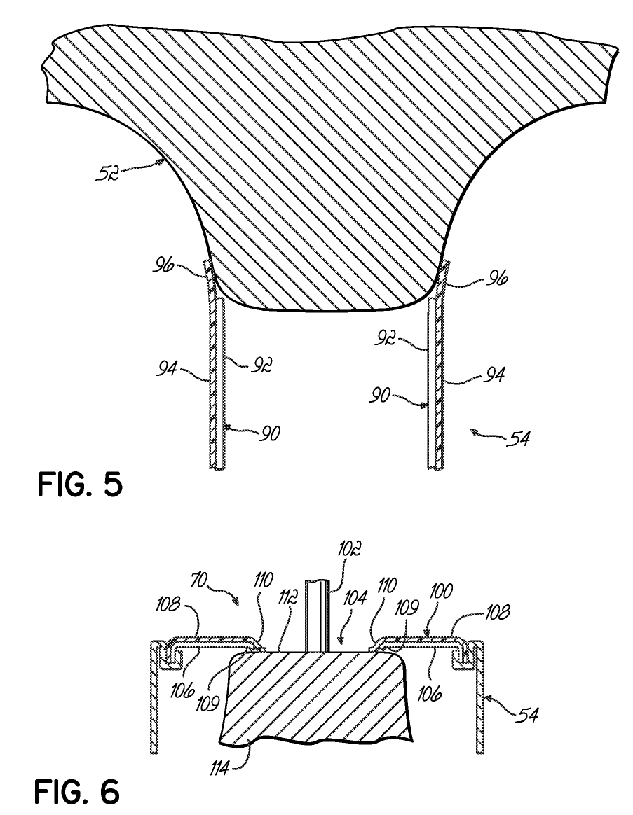

FIG. 4 illustrates a cross-section through a portion of the instrument panel 52 which defines a cavity 72 for a storage compartment, or glove box 66. The glove box 66 includes a selectively openable door 74 covering the cavity 72. In accordance with the principles of the present invention, the door 74 comprises a rigid substrate 76 defining the door structure, and a pliable cover layer 78 disposed over the substrate 76. In the embodiment shown, the substrate 76 is formed from first and second substrate sections 76a, 76b that are joined together, for example by snap fit, heat or friction welding, adhesives, or various other methods, as known in the art. Alternatively, the substrate 76 may be formed as a single, unitary piece to which the pliable cover layer 78 is subsequently added, such as by a two-shot molding process. The pliable cover layer 78 includes resilient, non-corrugate, free ends extending outwardly around the periphery of the rigid substrate 76 to define a flexible flanges 80 that are cantilevered from the substrate 76 and which contact corresponding peripheral edges 82 of the cavity 72 formed in the instrument panel 52 when the door 74 is in the closed position, as depicted in FIG. 4. With the door 74 in the closed position, the flexible flanges 80, cooperate with the corresponding peripheral edges 82 of the cavity 72 such that no visible gaps are apparent between the instrument panel 52 and the door 74.

With continued reference to FIG. 3, and referring further to FIG. 5, another embodiment in accordance with the present invention is depicted, wherein the trim assembly comprises a forward end 86 of the center console 54, adjacent the instrument panel 52. The center console 52 comprises sidewalls 90 defined by a rigid substrate 92 with a pliable cover layer 94 disposed thereon. Portions of the pliable cover layer 94 adjacent the instrument panel 52 include resilient, non-corrugate free ends extending outwardly from the substrate to define flexible flanges 96 cantilevered from the substrate 92 and contacting the instrument panel 52 such that no visible gaps are apparent between the forward end 86 of the center console 54 and the instrument panel 52.

FIG. 6 depicts yet another exemplary embodiment wherein an automotive trim assembly forms the top cover 100 of the center console 52 and surrounds a shifter assembly 70. The shifter assembly 70 includes a shift handle 102 extending upwardly from a slot 104 defined in the cover 100. The shift handle 102 is movable within the slot 104 to various positions for selecting a drive gear of the automobile. The top cover 100 comprises a rigid substrate 106 and a pliable cover layer 108 disposed on the substrate 106. The cover layer 106 includes a non-corrugate, free end extending from the peripheral edge 109 of that portion of the substrate 106 that defines the slot 104 to form flexible flanges 110 that are cantilevered from the substrate member 106 and contact an upper surface 112 of a shifter plate 114 to which the shift handle 102 is attached. The flanges 110 of the cover layer 108 provide a seal between the top cover 100 and the shifter plate 114 and ensure that no gaps are visible between the top cover 100 and the shifter plate 114.

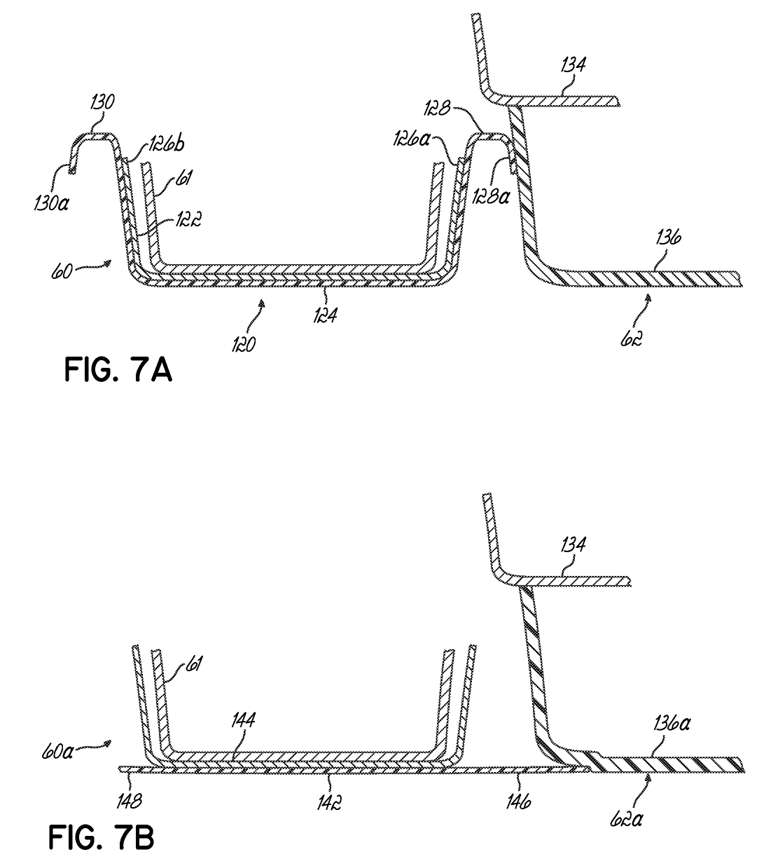

FIG. 7A illustrates another embodiment of a trim assembly in accordance with the principles of the invention, wherein the trim assembly comprises a cover 120 for a frame member 61 of the B-pillar assembly 60 of the automobile. In this embodiment, the B-pillar cover 120 comprises a rigid substrate member 122 adapted to fit adjacent the B-pillar frame member 61, and a pliable cover layer 124 on the substrate 122. Portions of the cover layer 124 at oppositely disposed fore and aft edges 126a, 126b of the substrate 122 include resilient, non-corrugate free ends extending outwardly from the edges 126a, 126b of the substrate member 122 to define flexible flanges 128, 130 that are cantilevered from the substrate member 122 and which contact a portion of an adjacent vehicle door (only font door 62 is shown) such that no gaps are visible between the B-pillar trim assembly 120 and the door 62.

In the embodiment shown, the door 62 includes a steel door member 134 and a corresponding door trim panel 136. The flexible flanges 128, 130 of the pliable cover layer 124 extend outwardly from the B-pillar substrate 122, and an end portion 128a, of flange 128 is angled back in a direction toward the interior 50 of the vehicle to facilitate engaging the door trim panel 136 when door 62 is in the closed position, as depicted in FIG. 7A. While the B-pillar cover 120 of FIG. 7A is depicted with only the front door 62, it will be recognized that the flexible flange 130 on the opposite side of the B-pillar cover 120 can be adapted to engage the corresponding rear door 64. Flange 130 further includes an end portion 130a that is angled back toward the interior 50 of the automobile to engage a door trim panel on the rear door 64, in a manner similar to that described above for flange 128.

FIG. 7B depicts yet another exemplary embodiment of a B-pillar cover 140 similar to that described above with respect to FIG. 7A. In this embodiment, free ends of the pliable cover layer 142 extend outwardly from the B-pillar substrate member 144, without bends, to define flexible flanges 146, 148 cantilevered from the substrate member 144. The flexible flange 146 contacts an edge of the door trim panel 136a when the door 62a is in the closed position, as depicted in FIG. 7B, so no gaps are visible between the B-pillar assembly 60a and the door 62a. While not specifically illustrated, the flexible flange 148 on the opposite side of the B-pillar cover 140 functions in the same manner to engage rear door 64.

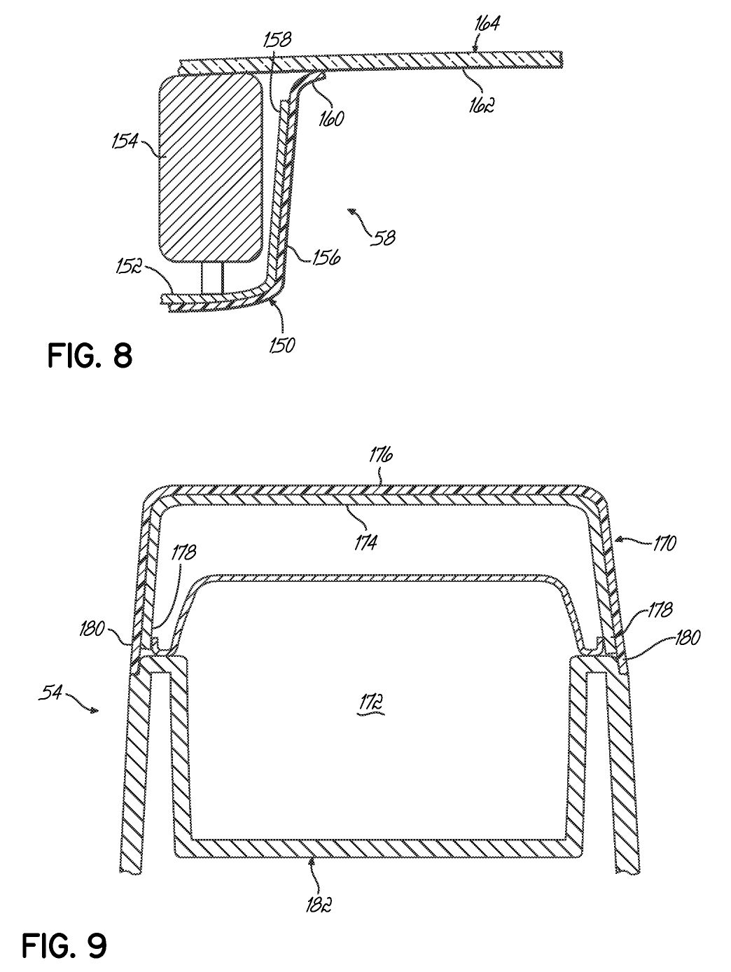

FIG. 8 depicts yet another exemplary embodiment of an automotive trim assembly in the form of an A-pillar cover 150. The A-pillar cover 150 comprises a rigid substrate member 152 surrounding a frame member 154 of the A-pillar assembly 58, and a pliable cover layer 156 disposed on the rigid substrate member 152. Resilient, non-corrugate free ends of the pliable cover layer 156 extend outwardly from the edge 158 of the substrate member 152 to define flexible flanges 160 that are cantilevered from the substrate member 152 and which contact an interior surface 162 of the windshield 164 of the automobile when the A-pillar cover 150 is installed in the automobile, such that no visible gaps are apparent between the A-pillar cover 150 and the windshield 164.

FIG. 9 depicts yet another exemplary embodiment of an automotive interior trim assembly, in accordance with the principles of the present invention, in the form of a cover 170 for a storage compartment 172 of the center console 54. The cover 170 of the center console 54 comprises a rigid substrate member 174 defining an upper portion of the cover 170, and a pliable cover layer 176 disposed on the substrate member 174. Resilient, non-corrugate, free ends of the pliable cover layer 176 extend outwardly from the lower peripheral edge 178 of the substrate member 174 to define flexible flanges 180 cantilevered from the substrate member 174 and contacting a base portion 182 of the center console 54 when the cover 170 is in the closed position, as depicted in FIG. 9.

Automotive trim assemblies, such as glove box doors 74, center consoles 54, console top covers 100, A-pillar and B-pillar covers 120, 140, 150, console storage compartment covers 170, or various other interior trim assemblies, may be formed from injection moldable polymers in the same manner described above for instrument panel 12 and door panel 18. For example, the rigid substrates 76, 92, 106, 122, 144, 152, 174 of the trim assemblies may be formed from thermoplastic olefin, acrylonitrile butadiene styrene, styrene maleic anhydride, polycarbonate/acrylonitrile butadiene styrene alloy, or other materials suitable for molding a rigid substrate member. The pliable cover layers 78, 94, 108, 124, 142, 156, 176 may be formed from vinyl, thermoplastic elastomer, PVC, or other suitable materials for molding the flexible cover layers 78, 94, 108, 124, 142, 156, 176. Alternatively, the cover layers 78, 94, 108, 124, 142, 156, 176 may be formed from fabric or leather and fitted over the molded substrates 76, 92, 106, 122, 144, 152, 174, as known in the art. Advantageously, the instrument panel 12 and door panel 18 of the present invention may be formed in a two-shot molding operation wherein the rigid substrates 76, 92, 106, 122, 144, 152, 174 are formed during a first shot of the molding process, and the cover layers 78, 94, 108, 124, 142, 156, 176 are molded over the substrates 76, 92, 106, 122, 144, 152, 174 during a second shot of the molding operation.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

1. An automotive instrument panel, comprising:
a substrate member defining the general shape of the instrument panel and comprising a central substrate section and first and second lateral substrate sections, said lateral substrate sections having respective lateral end portions configured to confront respective portions of adjacent door panels of an automobile in which the instrument panel is to be used; and
a pliable cover layer disposed on said substrate member and flexibly coupling said first and second lateral substrate sections to said central substrate section;
said substrate member together with said cover layer defining resilient engagement areas proximate said lateral end portions of said substrate member which contact the adjacent door panels when the door panels are in closed positions.

2. The instrument panel of claim 1, wherein said first and second lateral substrate sections are displaced toward said central substrate section to accommodate the door panels in their respective closed positions.

3. An automotive interior trim assembly, comprising:
an instrument panel, comprising:
a substrate member defining the general shape of the instrument panel and including a central substrate section and first and second lateral substrate sections, said lateral substrate sections having respective lateral ends, and
a pliable, first cover layer disposed on said substrate member and flexibly coupling said first and second lateral substrate sections to said central substrate, said first cover layer cooperating with said substrate member to define resilient engagement areas proximate said lateral ends of said first and second lateral substrate sections; and
a door panel hingedly secured adjacent said instrument panel, proximate one of said lateral ends of said substrate member, for movement between open and closed positions;
said door panel contacting said instrument panel at one of said resilient engagement areas when said door panel is in said closed position.

4. The trim assembly of claim 3, wherein said lateral substrate section is displaced toward said central substrate section when said door panel is in said closed position.

5. The trim assembly of claim 3, wherein said door panel comprises first and second door substrate sections and a pliable, second cover layer disposed over said first and second door substrate sections;
said first and second door substrate sections flexibly coupled by said second cover layer; and
said second door substrate section contacting one of said first and second lateral substrate sections of said instrument panel when said door panel is in said closed position.

6. The trim assembly of claim 5, wherein at least one of said second door substrate sections and said lateral substrate sections is displaced when said door panel is in said closed position.

7. A method of finishing an interior of an automobile, comprising:
installing an instrument panel within the interior of the automobile between laterally opposed door panels of the automobile, the instrument panel comprising a rigid substrate member including a central substrate section and first and second lateral substrate sections, and a pliable cover layer disposed over the substrate member and flexibly coupling the first and second lateral substrate sections to the central substrate section, the substrate member and cover layer together defining resilient engagement areas at lateral ends of the first and second lateral substrate sections;
contacting a door panel of the automobile with the instrument panel, adjacent a resilient engagement area of the substrate member, when the door panel is in a closed position; and
displacing at least one of the first and second lateral substrate sections toward the central substrate section to accommodate the door panel.

8. An automotive interior trim assembly, comprising:
a rigid substrate member defining the general shape of the trim assembly and having an edge portion defining a boundary of the trim assembly proximate an adjacent automotive component;
a pliable cover layer on said substrate;
said cover layer including a resilient, non-corrugate, free end extending outwardly from said edge portion of said substrate member to define a flexible flange cantilevered from said substrate member and contacting the adjacent automotive component such that no visible gaps are apparent between the trim assembly and the adjacent component.

9. The automotive interior trim assembly of claim 8, wherein at least one of said trim assembly and the adjacent component are movable relative to the other one of said trim assembly and the adjacent component.

10. The automotive trim assembly of claim 9, wherein the trim assembly is a cover for a B-pillar of an automobile, and wherein said flexible flange contacts a door of the automobile when the door is in a closed position.

11. The automotive trim assembly of claim 9, wherein the trim assembly comprises a center console of an automobile, and wherein said flexible flange contacts an instrument panel of the automobile.

12. The automotive trim assembly of claim 9, wherein the trim assembly is a lid for a center console of an automobile, and wherein said flexible flange contacts a base portion of the center console when said lid is in a closed position.

13. The automotive trim assembly of claim 9, wherein the trim assembly is a door for a glove box in an instrument panel of an automobile, and wherein said flexible flange contacts a surface of the instrument panel.

14. The automotive trim assembly of claim 9, wherein the trim assembly is a cover over a shifter assembly of an automobile, and wherein said flexible flange contacts an movable upper surface of the shifter assembly.

15. The automotive interior trim assembly of claim 8, wherein the trim assembly is a cover for an A-pillar of an automobile, and wherein said flexible flange contacts a windshield of the automobile.
